(19) United States
(12) Patent Application Publication
(10) Pub. No.: US 2024/0365401 A1
(43) Pub. Date: Oct. 31, 2024

(54) WIRELESS COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN); Xinlei YU, Dongguan (CN)

(21) Appl. No.: 18/762,139

(22) Filed: Jul. 2, 2024

Related U.S. Application Data
(63) Continuation of application No. PCT/CN2022/072337, filed on Jan. 17, 2022.

(51) Int. Cl. H04W 74/0833; H04L 1/1867

(52) U.S. Cl. CPC H04W 74/085; H04L 1/1887

(57) ABSTRACT

Disclosed are a wireless communication method and a terminal device. The method includes: in a case that a random access contention resolution timer expires and a physical downlink control channel PDCCH for scheduling retransmission of a message Msg3 is not received before the random access contention resolution timer expires, considering, by a terminal device, that contention resolution does not succeed; and/or, in a case that the random access contention resolution timer expires and the PDCCH for scheduling the retransmission of the Msg3 is received before the random access contention resolution timer expires, skipping, by the terminal device, considering that contention resolution fails.

### CROSS-REFERENCE TO RELATED APPLICATIONS

This application is a continuation of International Application No. PCT/CN2022/072337, filed on Jan. 17, 2022, the disclosure of which is hereby incorporated by reference in its entirety.

### TECHNICAL FIELD

Embodiments of this application relate to the field of communications, and specifically, to a wireless communication method and a terminal device.

### BACKGROUND

In a contention-based random access process, after a terminal device sends a message 3 (Msg3) each time, the terminal device starts or restarts a random access contention resolution timer (ra-ContentionResolutionTimer), and monitors a physical downlink control channel (PDCCH) within a running time of the timer to receive a message 4 (Msg4). If the terminal device does not receive a PDCCH scrambled by a cell radio network temporary identifier (C-RNTI) or a temporary cell radio network temporary identifier (TC-RNTI) until the ra-ContentionResolutionTimer expires, the terminal device considers that random access fails this time and tries to initiate random access again.

In a terrestrial networks (TN) system, after sending a Msg3, a terminal device starts or restarts a ra-ContentionResolutionTimer, and monitors a PDCCH within a running time of the timer. The terminal device stops the ra-ContentionResolutionTimer only after receiving a Msg4. In a case of receiving a PDCCH for scheduling retransmission of the Msg3, the terminal device restarts the timer ra-ContentionResolutionTimer after completing the retransmission of the Msg3.

In a non-terrestrial networks NTN) system, a round-trip time (RTT) between a terminal device and a network device greatly increases. To avoid unnecessary PDCCH monitoring of the terminal device, a time offset is introduced for a start time of a ra-ContentionResolutionTimer in the NTN system. As a result, there may be a relatively large time offset between a ra-ContentionResolutionTimer that is started based on retransmission of a Msg3 and a ra-ContentionResolutionTimer that is started based on initial transmission of the Msg3. That is, before the ra-ContentionResolutionTimer is restarted based on retransmission of a Msg3, the ra-ContentionResolutionTimer that is started based on initial transmission of the Msg3 has expired. Therefore, the terminal device determines that contention resolution fails, and the terminal device needs to try random access again. This increases a random access delay.

### SUMMARY

This application provides a wireless communication method and a terminal device, which is conducive to preventing a terminal device from frequently initiating random access, so that a random access delay is reduced, thereby improving a random access success rate.

According to a first aspect, a wireless communication method is provided, and the method includes: in a case that a random access contention resolution timer expires and a physical downlink control channel PDCCH for scheduling retransmission of a message Msg3 is not received before the random access contention resolution timer expires, considering, by a terminal device, that contention resolution does not succeed.

According to a second aspect, a terminal device is provided, and the terminal device is configured to execute the method according to the foregoing first aspect or implementations of the first aspect.

Specifically, the terminal device includes a functional module configured to execute the method according to the foregoing first aspect or implementations of the first aspect.

According to a third aspect, a terminal device is provided, and the terminal device includes a processor and a memory. The memory is configured to store a computer program, and the processor is configured to invoke and run the computer program stored in the memory to execute the method according to the foregoing first aspect or implementations of the first aspect.

According to a fourth aspect, a chip is provided, and the chip is configured to implement the method according to the foregoing first aspect or implementations of the first aspect.

Specifically, the chip includes a processor, configured to invoke a computer program from a memory and run the computer program, to cause a device on which the chip is installed to execute the method according to the foregoing first aspect or implementations of the first aspect.

According to a fifth aspect, a computer-readable storage medium is provided, and the computer-readable storage medium is configured to store a computer program, where the computer program causes a computer to execute the method according to the foregoing first aspect or implementations of the first aspect.

According to a sixth aspect, a computer program product is provided, and the computer program product includes computer program instructions, where the computer program instructions cause a computer to execute the method according to the foregoing first aspect or implementations of the first aspect.

According to a seventh aspect, a computer program is provided. The computer program, when running on a computer, causes the computer to execute the method according to the foregoing first aspect or implementations of the first aspect.

By using the foregoing technical solutions, in a case that a random access contention resolution timer expires and a PDCCH for scheduling retransmission of a message Msg3 is not received before the random access contention resolution timer expires, a terminal device considers that contention resolution does not succeed; and/or, in a case that the random access contention resolution timer expires and the PDCCH for scheduling the retransmission of the message Msg3 is received before the random access contention resolution timer expires, the terminal device does not consider that contention resolution fails, and further determines, according to a receiving status of a Msg4 after the Msg3 is retransmitted, whether the contention resolution succeeds. This is conducive to avoiding a problem of the terminal device frequently initiating random access, where the problem is resulted from that the terminal device considers that the contention resolution fails as soon as the random access contention resolution timer expires, so that a random access delay is reduced, thereby improving a random access success rate.

### BRIEF DESCRIPTION OF DRAWINGS

FIG. 1A to FIG. 1C each are a schematic diagram of an architecture of a communications system according to an embodiment of this application.

FIG. 2 is an architectural diagram of an NTN system based on a transparent payload satellite.

FIG. 3 is an architectural diagram of an NTN system based on a regenerative payload satellite.

FIG. 4 is a schematic diagram of a four-step random access process.

FIG. 5 is a schematic diagram of a mechanism for determining random access contention resolution in a related technology.

FIG. 6 is a schematic diagram of a wireless communication method according to an embodiment of this application.

FIG. 7 is a schematic diagram of a mechanism for determining random access contention resolution according to an embodiment of this application.

FIG. 8 is a schematic block diagram of a terminal device according to an embodiment of this application.

FIG. 9 is a schematic block diagram of a communications device according to another embodiment of this application.

FIG. 10 is a schematic block diagram of a chip according to an embodiment of this application.

FIG. 11 is a schematic block diagram of a communications system according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. For embodiments of this application, all other embodiments obtained by a person of ordinary skill in the art without creative efforts fall within the protection scope of this application.

The technical solutions in embodiments of this application may be applied to various communications systems, for example, a global system for mobile communications (GSM), a code division multiple access (CDMA) system, a wideband code division multiple access (WCDMA) system, general packet radio service (GPRS), a long-term evolution (LTE) system, an advanced long-term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area network (WLAN), wireless fidelity (WiFi), a fifth-generation (5th-Generation, 5G) system, or another communications system.

Generally, a quantity of connections supported by a conventional communications system is limited and is also easy to implement. However, with development of communication technologies, a mobile communications system not only supports conventional communication, but also supports, for example, device-to-device (D2D) communication, machine to machine (M2M) communication, machine type communication (MTC), vehicle to vehicle (V2V) communication, or vehicle to everything (V2X) communication. Embodiments of this application may also be applied to these communications systems.

Optionally, a communications system in embodiments of this application may be applied to a carrier aggregation (CA) scenario, a dual connectivity (DC) scenario, or a standalone (SA) networking scenario.

The communications system in embodiments of this application may be applied to an unlicensed spectrum, and the unlicensed spectrum may also be considered as a shared spectrum. Alternatively, the communications system in embodiments of this application may be applied to a licensed spectrum, and the licensed spectrum may also be considered as a non-shared spectrum.

Embodiments of this application may be applied to a non-terrestrial networks (NTN) system or a terrestrial networks (TN) system.

Embodiments of this application are described with reference to a network device and a terminal device. The terminal device may also be referred to as a user equipment (UE), an access terminal, a user unit, a user station, a mobile site, a mobile station, a remote station, a remote terminal, a mobile device, a user terminal, a terminal, a wireless communications device, a user agent, a user apparatus, or the like.

The terminal device may be a station (ST) in a WLAN, a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, a terminal device in a future evolved public land mobile network (PLMN), or the like.

In embodiments of this application, the terminal device may be deployed on land, including being indoors or outdoors, may be handheld, wearable, or vehicle-mounted. The terminal device may be deployed on water (for example, on a ship), or may be deployed in the air (for example, on an airplane, an air balloon, or a satellite).

In embodiments of this application, the terminal device may be a mobile phone, a tablet computer (Pad), a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, or the like. The terminal device involved in embodiments of this application may also be referred to as a terminal, a user equipment (UE), an access terminal device, a vehicle-mounted terminal, an industrial control terminal, a UE unit, a UE station, a mobile site, a mobile station, a remote station, a remote terminal device, a mobile device, a UE terminal device, a wireless communications device, a UE agent, a UE apparatus, or the like. The terminal device may also be fixed or mobile.

By way of example rather than limitation, in embodiments of this application, the terminal device may alternatively be a wearable device. The wearable device may also be referred to as an intelligent wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, wearable smart devices may include a full-featured and large-sized device that can provide full or partial functions without relying on a smart phone, for example, a smart watch or smart glasses, and devices that focus on only a specific type of application function and need to cooperate with another device such as a smart phone for use, for example, various smart bracelets and smart jewelries for physical sign monitoring.

In embodiments of this application, the network device may be a device configured to communicate with a mobile device. The network device may be an access point (AP) in a WLAN, a base transceiver station (BTS) in GSM or CDMA, a NodeB (NB) in WCDMA, an evolved Node B (eNB or eNodeB) in LTE, a relay station or an access point, a vehicle-mounted device, a wearable device, a network device (gNB) in an NR network, a network device in a future evolved PLMN network, a network device in an NTN network, or the like.

By way of example rather than limitation, in embodiments of this application, the network device may have a mobility characteristic. For example, the network device may be a mobile device. In some embodiments of this application, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments of this application, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro station or may belong to a base station corresponding to a small cell. The small cell herein may include a metro cell, a micro cell, a pico cell, a femto cell, or the like. These small cells have a characteristic of a small coverage range and low transmit power, and are applicable to providing a high-rate data transmission service.

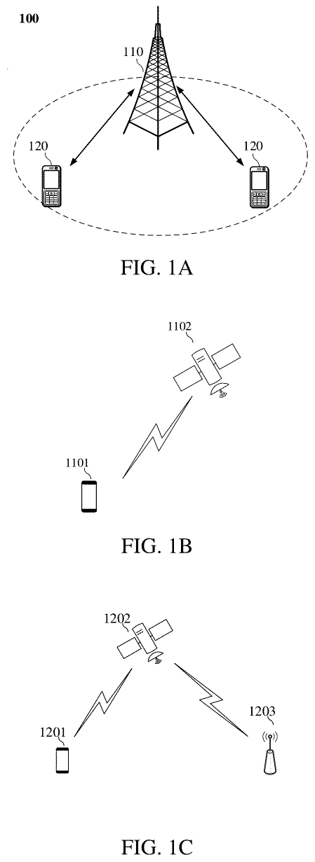

Exemplarily, FIG. 1A is a schematic diagram of an architecture of a communications system according to an embodiment of this application. As shown in FIG. 1A, the communications system 100 may include a network device 110, and the network device 110 may be a device that communicates with a terminal device 120 (or referred to as a communications terminal or a terminal). The network device 110 may provide communication coverage for a specific geographic area, and may communicate with a terminal device within the coverage area.

FIG. 1A exemplarily shows one network device and two terminal devices. In some embodiments of this application, the communications system 100 may include a plurality of network devices, and another quantity of terminal devices may be included within a coverage range of each network device, which is not limited in embodiments of this application.

Exemplarily, FIG. 1B is a schematic diagram of an architecture of another communications system according to an embodiment of this application. Referring to FIG. 1B, the communications system includes a terminal device 1101 and a satellite 1102, and wireless communication may be performed between the terminal device 1101 and the satellite 1102. A network formed between the terminal device 1101 and the satellite 1102 may also be referred to as an NTN. In the architecture of the communications system shown in FIG. 1B, the satellite 1102 may have a function of a base station, and the terminal device 1101 and the satellite 1102 may directly communicate with each other. Under this system architecture, the satellite 1102 may be referred to as a network device. In some embodiments of this application, the communications system may include a plurality of network devices 1102, and another quantity of terminal devices may be included within a coverage range of each network device 1102, which is not limited in embodiments of this application.

Exemplarily, FIG. 1C is a schematic diagram of an architecture of another communications system according to an embodiment of this application. Referring to FIG. 1C, the communications system includes a terminal device 1201, a satellite 1202, and a base station 1203, wireless communication may be performed between the terminal device 1201 and the satellite 1202, and communication may be performed between the satellite 1202 and the base station 1203. A network formed between the terminal device 1201, the satellite 1202, and the base station 1203 may also be referred to as an NTN. In the architecture of the communications system shown in FIG. 1C, the satellite 1202 may not have a function of a base station, and communication between the terminal device 1201 and the base station 1203 needs to be forwarded by using the satellite 1202. Under this type of system architecture, the base station 1203 may be referred to as a network device. In some embodiments of this application, the communications system may include a plurality of network devices 1203, and another quantity of terminal devices may be included within a coverage range of each network device 1203, which is not limited in embodiments of this application.

It should be noted that FIG. 1A to FIG. 1C are merely examples of systems to which this application is applicable. Certainly, the methods shown in embodiments of this application may also be applied to another system, such as a 5G communications system or an LTE communications system. This is not specifically limited in embodiments of this application.

In some embodiments of this application, the wireless communications systems shown in FIG. 1A to FIG. 1C may further include another network entity such as a mobility management entity (MME) or an access and mobility management function (AMF), which is not limited in embodiments of this application.

It should be understood that a device having a communication function in a network or a system in embodiments of this application may be referred to as a communications device. The communications system 100 shown in FIG. 1A is used as an example. The communications device may include a network device 110 and a terminal device 120 each of which has a communication function. The network device 110 and the terminal device 120 may be the foregoing specific devices, and details are not described herein again. The communications device may further include another device in the communications system 100, such as a network controller or a mobility management entity. This is not limited in embodiments of this application.

It should be understood that the terms “system” and “network” may often be used interchangeably herein. In this specification, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

It should be understood that, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In the descriptions of embodiments of this application, the term “corresponding” may mean that there is a direct or indirect correspondence between two elements, or that there is an association between two elements, or that there is a relationship of “indicating” and “being indicated”, “configuring” and “being configured”, or the like.

In some embodiments of this application, the “predefining” may be implemented by pre-storing a corresponding code or table in a device (for example, including the terminal device and the network device) or in other manners that may be used for indicating related information, and a specific implementation thereof is not limited in this application. For example, pre-defining may refer to being defined in a protocol.

In some embodiments of this application, the “protocol” may refer to a standard protocol in the communication field, which may include, for example, an LTE protocol, an NR protocol, and a related protocol applied to a future communications system. This is not limited in this application.

In some scenarios, according to functions provided by satellites, the satellites may include two types: transparent payload satellites and regenerative payload satellites. The transparent payload satellite provides only functions such as radio frequency filtering, frequency conversion, and amplification, provides only transparent forwarding of signals without changing waveform signals forwarded by the satellite. The regenerative payload satellite, in addition to providing functions such as radio frequency filtering, frequency conversion, and amplification, may further provide functions such as demodulation or decoding, routing or conversion, and encoding or modulation, and has some or all functions of a base station.

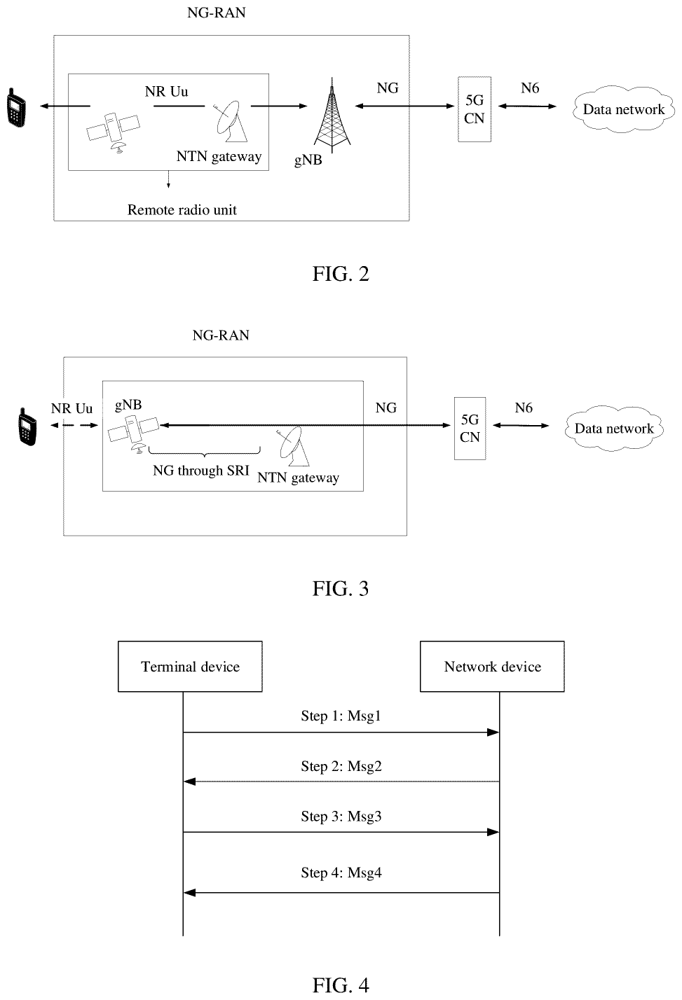

By way of example rather than limitation, FIG. 2 is an architectural diagram of a system based on a transparent payload satellite, and FIG. 3 is an architectural diagram of a system based on a regenerative payload satellite.

As shown in FIG. 2, the NTN system based on a transparent payload satellite includes an NTN gateway and a satellite. The NTN gateway and the satellite may be considered as constituting a remote radio unit that is used for communication between a terminal device and an access network device (for example, a gNB) in a TN system. This is equivalent to that the remote radio unit provides a function of an NR Uu interface for communication between the terminal device and the access network device. In some embodiments, the NTN gateway communicates with the satellite by using a feeder link, and the satellite communicates with the terminal device by using a service link.

Further, the access network device (for example, a gNB) in the TN system communicates with a 5G core network (CN) by using a next-generation NG) interface, and the 5G CN communicates with a data network by using an N6 interface. An access network device of the NTN system and the access network device of the TN system form a next-generation access network (NG-RAN).

As shown in FIG. 3, the NTN system based on a regenerative payload satellite may also include an NTN and a satellite. Different from that in the NTN system based on a transparent payload satellite, satellites may communicate with each other. Specifically, the satellites communicate with each other by using a satellite radio interface (SRI) or an inter-satellite link (InterStar link).

In some scenarios, the satellite may function as an access network device to communicate with a terminal device. For example, the satellite may communicate with the terminal device by using an NR Uu interface. The satellite may communicate with a 5G CN by using an NG interface, and the 5G CN may communicate with a data network by using an N6 interface. It may be considered that the NTN system forms a next-generation access network (NG-RAN).

It should be understood that FIG. 1 to FIG. 3 are merely examples of application scenarios of this application, and shall not be construed as a limitation to this application.

For example, in other alternative embodiments, the NTN system may further include an unmanned aircraft system.

Specifically, the satellites in FIG. 2 to FIG. 3 may be replaced with a UAS platform. For example, the UAS platform includes but is not limited to a high altitude platform station (HAPS).

In some scenarios, a random access process is mainly triggered by the following events:
establishment of a wireless connection during initial access of a terminal device: switching from a radio resource control (RRC) idle (RRC_IDLE) state to an RRC_CONNECTED state is to be identified;
an RRC connection reestablishment process: a UE reestablishes a wireless connection after a wireless link fails;
a handover: the terminal device needs to establish uplink synchronization with a new cell;
in an RRC_CONNECTED state, downlink DL) data arrives, and in this case, an uplink (UL) is in an out-of-synchronization state;
in an RRC_CONNECTED state, uplink (UL) data arrives, and in this case, a UL is in an out-of-synchronization state or does not have a physical uplink control channel PUCCH) resource used to send a scheduling request (SR);
an SR failure;
a synchronization reconfiguration request from RRC;
switching of the UE from an RRC_INACTIVE state to an RRC_CONNECTED state;
establishment of time calibration in a process of adding a secondary cell (SCell);
requesting of other system information (SI); and
beam failure recovery.

In an NR system, a four-step random access process is supported, and specifically includes a process of sending a message 1 (Msg1) to a message 4 (Msg4). In an example, as shown in FIG. 4, the four-step random access process includes the following steps:
Step 1: A terminal device sends a random access preamble (Preamble, that is, the Msg1) to a network device.

The random access preamble may also be referred to as a preamble, a random access preamble sequence, a preamble sequence, or the like.

Specifically, the terminal device may select a physical random access channel (PRACH) resource, and the PRACH resource may include a time domain resource, a frequency domain resource, and a code domain resource. The network device sends, to the terminal device, a parameter related to random access by broadcasting a system information block (SIB) 1, where a reference signal receiving power (RSRP) threshold (rsrp-ThresholdSSB), with respect to a synchronization signal block (SSB), in a random access common configuration information element (RACH-ConfigCommon IE) is used by the terminal device to perform SSB selection. The terminal device compares an RSRP measurement result of each SSB with the rsrp-ThresholdSSB, and selects an SSB with a measurement value higher than the configured threshold to perform access. If no SSB meets the configured threshold, one of the SSBs is randomly selected to perform access. Each SSB corresponds to a group of random access preamble resources and random access occasion (RACH Occasion, RO) resources. The terminal device randomly selects from contention-based random access resources in the selected SSB, and sets the PREAMBLE_INDEX (to a selected random access preamble. The network device may estimate a transmission delay between the network device and the terminal device according to the preamble and calibrate uplink timing based on the preamble, and may generally determine a size of a resource required by the terminal device for transmitting the Msg3. To enable the network device to more accurately learn a size of the to-be-transmitted Msg3 and allocate a proper uplink resource, the preamble is divided into a preamble group A and a preamble group B. If the preamble group B exists in a random access resource, the terminal device may perform selection on the preamble groups according to the size of the Msg3 and a path loss.
Step 2: The network device sends a random access response (RAR, that is, the Msg2) to the terminal device.

After sending the preamble to the network device, the terminal device may enable a random access response window (ra-ResponseWindow), and detect, in the ra-Response Window, a corresponding PDCCH according to a random access radio network temporary identifier (RA-RNTI). The RA-RNTI is related to a PRACH time-frequency resource used by the terminal device to send the Msg1.

After the terminal device successfully receives the PDCCH scrambled by the RA-RNTI, the terminal device can obtain a PDSCH scheduled by the PDCCH. The PDSCH includes a RAR, and the RAR specifically includes the following information:
a back-off indicator (BI) included in a subheader of the RAR, used to indicate a back-off time of retransmitting the Msg1;
a random access preamble identifier RAPID) in the RAR: a response of the network device to the received PREAMBLE_INDEX;
a timing advance group (TAG) included in data (payload) of the RAR, used to adjust uplink timing;
a UL grant: an uplink resource indicator used to schedule the Msg3; and
a temporary cell RNTI (Temporary C-RNTI, TC-RNTI): used to scramble a PDCCH (used for initial access) for scheduling the Msg4, and may also be used to scramble a PDCCH for scheduling retransmission of the Msg3.

If the terminal device receives the PDCCH scrambled by the RAR-RNTI and the RAR includes the PREAMBLE_INDEX sent in the Msg1, the terminal device considers that the RAR is successfully received.

If the terminal device detects the PDCCH scrambled by the RA-RNTI, a physical downlink shared channel (PDSCH) scheduled by the PDCCH may be obtained. The PDSCH includes the RAR corresponding to the preamble.

If the PDCCH scrambled by the RA-RNTI is not received during running of the ra-Response Window, or if the PDCCH scrambled by the RA-RNTI is received during running of the ra-ResponseWindow, but the RAR does not include the RAPID corresponding to the PREAMBLE_INDEX, it is considered that the RAR fails to be received. In this case, if a quantity of transmission times of the preamble does not exceed a maximum quantity of transmission times (preambleTransMax) configured by a network, that is, a threshold of a maximum quantity of transmission times of the Msg1, the terminal device needs to retransmit the Msg1. If the quantity of transmission times of the preamble exceeds the maximum quantity of transmission times (preambleTransMax) configured by the network, the terminal device reports a random access problem to a higher layer.
Step 3: The terminal device sends the Msg3.

After receiving the RAR message, the terminal device determines whether the RAR message belongs to the terminal device. For example, the terminal device may check the RAR message by using a preamble index. After determining that the RAR message belongs to the terminal device, the terminal device may generate the Msg3 in an RRC layer and send the Msg3 to the network device. The Msg3 needs to carry identity information of the terminal device and the like.

The Msg3 is mainly used to notify the network device of a trigger event of the random access. For different trigger events of random access, the Msg3 sent by the terminal device in step 3 may include different content. Specifically, the Msg3 may carry a terminal identity (that is, a contention resolution identity, used for contention resolution in step 4) and an establishment cause.

For example, for an initial access scenario, the Msg3 may include an RRC connection request message (RRC Setup Request) generated by the RRC layer. In addition, the Msg3 may further carry, for example, a 5G serving-temporary mobile subscriber identity (S-TMSI) of the terminal device, a random number, or the like.

For another example, for an RRC connection reestablishment scenario, the Msg3 may include an RRC connection reestablishment request message (RRC Reestabilshment Request) generated by the RRC layer. In addition, the Msg3 may further carry, for example, a cell radio network temporary identifier C-RNTI) and the like.

For another example, for a handover scenario, the Msg3 may include an RRC handover confirm message generated by the RRC layer, and the RRC handover confirm message carries a C-RNTI of the terminal device. In addition, the Msg3 may further carry information such as a buffer status report BSR). For another trigger event, for example, a scenario in which uplink or downlink data arrives, the Msg3 may include at least the C-RNTI of the terminal device.

In some embodiments, the Msg3 supports hybrid automatic repeat request (HARQ) retransmission.

The Msg3 is carried by using a physical uplink shared channel (PUSCH), a RAR in the Msg2 carries a UL grant of a PUSCH used for initial transmission of the Msg3, and the UL grant carried in the RAR is referred to as a RAR UL grant. Information carried in the RAR UL grant information may include time domain resource allocation information and frequency domain resource allocation information of the PUSCH, a power control command TPC, frequency hopping, an MCS, and the like.

If the network device does not properly receive the Msg3, the network device indicates scheduling information for retransmission of the Msg3 by using DCI. For example, in addition to the content included in the RAR UL grant, a DCI format 0_0 scrambled by using a temporary cell radio network temporary identifier (TC-RNTI) further carries a new data indicator (NDI), a redundancy version, and a HARQ process number.
Step 4: The network device sends, to the terminal device, a contention resolution message, that is, the Msg4.

After sending the Msg3 each time, the terminal device starts or restarts a random access contention resolution timer (ra-ContentionResolutionTimer), and monitors a PDCCH scrambled by a C-RNTI or a TC-RNTI during running of the ra-ContentionResolution Timer.

The Msg4 mainly has two functions: One is for contention conflict resolution, and the other is for the network device to transmit an RRC configuration message to the terminal device. The contention conflict resolution is mainly performed in the following two manners: In one manner, if the terminal device carries the C-RNTI in the Msg3, the Msg4 is scheduled by using the PDCCH scrambled by the C-RNTI. In another manner, if the terminal device does not carry the C-RNTI in the Msg3, for example, in an initial access scenario, the Msg4 is scheduled by using the PDCCH scrambled by the TC-RNTI. The terminal device receives a PDSCH that carries the Msg4, and determines, by matching a contention resolution identifier in a common control channel (CCCH) service data unit (SDU) in the PDSCH, whether contention is resolved, or in other words, whether contention resolution succeeds.

For a contention-based random access process, after the terminal device sends the Msg3 each time, the terminal device starts or restarts a timer ra-ContentionResolutionTimer, and monitors a PDCCH within a running time of the timer ra-ContentionResolutionTimer, to receive the Msg4. If the terminal device does not receive the PDCCH scrambled by the C-RNTI or the TC-RNTI until the ra-ContentionResolutionTimer expires, the terminal device considers that random access fails this time, and initiates random access again, that is, sends the Msg1 again. After a quantity of times the terminal device sends the Msg1 reaches a threshold, the terminal device indicates to the higher layer that a random access problem occurs.

In a TN system, after sending the Msg3, the terminal device starts or restarts a ra-ContentionResolutionTimer, and monitors a PDCCH within a running time of the timer ra-ContentionResolutionTimer. Compared with that in the TN system, in the NTN system, a round-trip time (RTT) between a terminal device and a network device greatly increases. To avoid unnecessary PDCCH monitoring by the terminal device, a time offset is introduced for a start time of the ra-ContentionResolution Timer in the NTN system.

In a related technology, the terminal device stops the ra-ContentionResolution Timer only when receiving the Msg4. In a case of receiving a PDCCH for scheduling retransmission of the Msg3, the terminal device restarts the timer ra-ContentionResolutionTimer after completing the retransmission of the Msg3. In the NTN system, because a start time of the ra-ContentionResolutionTimer is delayed by a time offset, the ra-ContentionResolutionTimer has expired within a time period after completion of the retransmission of the Msg3 by the terminal device and before restarting of the ra-ContentionResolution Timer. Therefore, the terminal device considers that contention resolution fails, and tries random access again. This increases a random access delay.

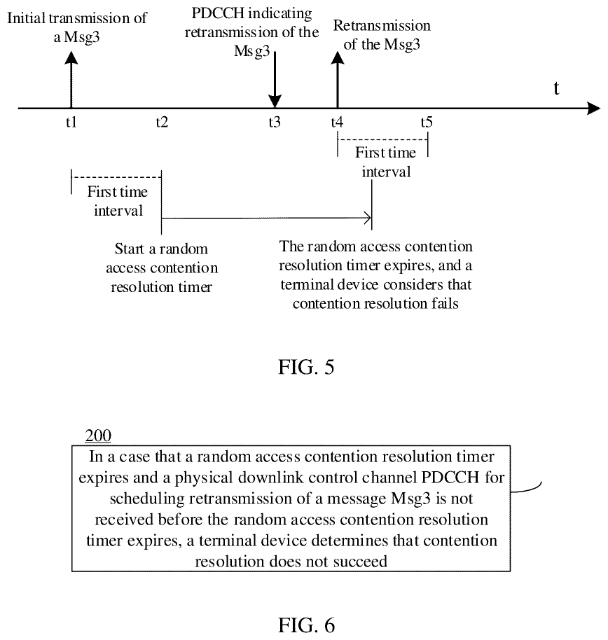

With reference to FIG. 5, a problem existing in the foregoing determining mechanism is described.

As shown in FIG. 5, a terminal device performs initial transmission of a Msg3 at a time t1, and after a first time interval following completion of the initial transmission of the Msg3, starts a ra-ContentionResolutionTimer at a time t2.

At a time t3, the terminal device receives a PDCCH that indicates retransmission of the Msg3 and is scrambled by a TC-RNTI, and the PDCCH indicates that the Msg3 is retransmitted at a time t4. The Ra-ContentionResolutionTimer expires at a time between the time t4 and a time t5. In this case, the terminal device considers that contention resolution fails, and needs to try random access again. This increases a random access delay, and reduces a random access success rate.

To facilitate understanding of the technical solutions in embodiments of this application, the following describes the technical solutions in this application in detail by using specific embodiments. The foregoing related technologies, as optional solutions, may be randomly combined with the technical solutions of embodiments of this application, all of which fall within the protection scope of embodiments of this application. Embodiments of this application include at least a part of the following content.

FIG. 6 is a schematic diagram of a wireless communication method 200 according to an embodiment of this application. As shown in FIG. 6, the method 200 includes the following content:
S210: In a case that a random access contention resolution timer (ra-ContentionResolutionTimer) expires and a physical downlink control channel PDCCH for scheduling retransmission of a message Msg3 is not received before the random access contention resolution timer expires, a terminal device considers that contention resolution does not succeed.

It should be understood that this embodiment of this application may be applied to an NTN system or a TN system. This is not limited in this application.

In other words, this embodiment of this application may be applied to a system that may have the following problem:

A PDCCH for scheduling retransmission of a Msg3 is received before a random access contention resolution timer that is started based on initial transmission of the Msg3 expires. However, before the random access contention resolution timer is restarted based on the retransmission of the Msg3, or before the retransmission of the Msg3, the random access contention resolution timer that is started based on the initial transmission of the Msg3 has expired. In this case, if the terminal device considers that contention resolution fails, a contention resolution misjudgment exists.

For example, in an NTN system, a time offset is added for starting of the random access contention resolution timer, and therefore the random access contention resolution timer has expired before the retransmission of the Msg3, or before the random access contention resolution timer is restarted, a random access contention resolution timer started last time has expired. Alternatively, for a TN system, due to a relatively long time during which the terminal device prepares the Msg3 or due to another reason, the random access contention resolution timer may have expired before the retransmission of the Msg3, or before the random access contention resolution timer is restarted, a random access contention resolution timer started last time has expired.

It should be understood that in this embodiment of this application, the TN system includes but is not limited to an NR system (or referred to as an NR-TN system) and an internet of things (IoT) system (or referred to as an IoT-TN system).

In some embodiments, the IoT system may include but is not limited to a narrow band internet of things (NB-IoT) system (or referred to as an NB-IoT-TN system) and an enhanced machine type communication (eMTC) system (or referred to as an eMTC-TN system).

In some embodiments, the terminal device is a UE in a TN system, for example, a UE in an NR system or a UE in an IoT system. A UE in an NB-IoT system or a UE in an eMTC system is used as an example.

It should be understood that in this embodiment of this application, the NTN system includes but is not limited to a new radio non-terrestrial networks (New Radio NTN, NR-NTN) system and an internet of things non-terrestrial networks (Internet of Things NTN, IoT-NTN) system.

In some embodiments, the IoT-NTN system may include at least one of the following:
an NB-IoT-based NTN system, or referred to as a narrowband internet of things over non-terrestrial networks (Narrow Band Internet of Things over NTN, NB-IoT-NTN) system; and
an eMTC-based NTN system, or referred to as an enhanced machine type communication over non-terrestrial networks (enhanced Machine Type Communication over NTN, eMTC-NTN) system.

With reference to a specific scenario, the following describes a start or restart occasion of the random access contention resolution timer.

Embodiment 1: The random access contention resolution timer is started or restarted at a first time domain symbol after sending of the Msg3 is completed.

It should be understood that the completion of the sending of the Msg3 herein may refer to completion of initial transmission of the Msg3, or may refer to completion of retransmission of the Msg3.

For example, the ra-ContentionResolution Timer is started at a first time domain symbol after the initial transmission of the Msg3 is completed, and the ra-ContentionResolutionTimer is restarted at a first time domain symbol after the retransmission of the Msg3 is completed.

Optionally, Embodiment 1 may be applied to a TN system, for example, an NR-TN system.

For example, for the NR-TN system, the terminal device may start or restart the ra-ContentionResolutionTimer at a first time domain symbol after the sending of the Msg3 is completed, or in other words, the terminal device starts or restarts the ra-ContentionResolutionTimer at a next time domain symbol after the sending of the Msg3 is completed.

Embodiment 2: The random access contention resolution timer is started or restarted at a first time domain symbol after a first time offset following completion of sending of the Msg3. It should be understood that the completion of the sending of the Msg3 herein may refer to completion of initial transmission of the Msg3, or may refer to completion of retransmission of the Msg3.

For example, the ra-ContentionResolution Timer is started at a first time domain symbol after a first time offset following the completion of the initial transmission of the Msg3, and the ra-ContentionResolutionTimer is restarted at a first time domain symbol after a first time offset following the completion of the retransmission of the Msg3.

Optionally, Embodiment 2 may be applied to an NTN system, for example, an NR-NTN system.

For example, for the NR-NTN system, the terminal device starts or restarts the ra-ContentionResolutionTimer at a first time domain symbol after a first time offset following the completion of the sending of the Msg3. In other words, the terminal device starts or restarts the ra-ContentionResolution Timer at a next time domain symbol after the first time offset following the completion of the sending of the Msg3.

In some embodiments, the first time offset is determined according to a round-trip time RTT between the terminal device and a network device, for example, the first time offset may be an RTT between the terminal device and the network device, denoted as UE-gNB RTT.

Embodiment 3: The random access contention resolution timer is started or restarted in a subframe in which a first PUSCH is retransmitted for a last time, and the first PUSCH is used to carry the Msg3. That is, the first PUSCH is a PUSCH that carries the Msg3, and is also referred to as a Msg3 PUSCH.

Optionally, Embodiment 3 may be applied to a TN system, for example, an IoT system, that is, an IoT-TN system, which may be specifically, for example, an NB-IoT system or an eMTC system.

For example, for an IoT system, the terminal device starts or restarts the ra-ContentionResolutionTimer in a subframe in which the Msg3 PUSCH is retransmitted for a last time.

Embodiment 4: The random access contention resolution timer is started after a first time offset following a subframe in which a second PUSCH is retransmitted for a last time, and the second PUSCH is used to carry the message 3. That is, the second PUSCH is a PUSCH that carries the Msg3, and is also referred to as a Msg3 PUSCH.

Optionally, Embodiment 4 may be applied to an NTN system, for example, an IoT-NTN system, which may be specifically, for example, an NB-IoT-NTN system or an eMTC-NTN system.

For example, for an IoT-NTN system, the terminal device starts or restarts the ra-ContentionResolutionTimer after a first time offset following a subframe in which the Msg3 PUSCH is retransmitted for a last time. That is, the first time offset is an interval between a time when the ra-ContentionResolution Timer is started or restarted and the subframe in which the Msg3 PUSCH is transmitted for a last time.

In some embodiments, the first time offset is determined according to a round-trip time RTT between the terminal device and a network device. For example, the first time offset may be an RTT between the terminal device and the network device, denoted as UE-gNB RTT.

Optionally, in Embodiment 4, a unit of the first time offset may be a subframe.

In some embodiments of this application, the method 200 further includes:
in a case that the random access contention resolution timer expires and the PDCCH for scheduling the retransmission of the Msg3 is not received before the random access contention resolution timer expires, discarding a TC-RNTI, where the TC-RNTI is used to scramble the PDCCH.

Specifically, in a case that the random access contention resolution timer expires and the PDCCH for scheduling the retransmission of the Msg3 is not received before the random access contention resolution timer expires, the terminal device considers that contention resolution fails. If a quantity of times the terminal device sends a Msg1 is less than a threshold, of a maximum quantity of transmission times of the Msg1, configured by a network device, the terminal device initiates a random access process again. Therefore, the terminal device may discard an RNTI, that is, a TC-RNTI, used to scramble the PDCCH for scheduling the retransmission of the Msg3. Further, in the random access process that is initiated again, the network device may configure a new TC-RNTI for the terminal device by using a RAR, to scramble the PDCCH for scheduling the retransmission of the Msg3.

In some embodiments of this application, the method 200 further includes:
in a case that the random access contention resolution timer expires and the PDCCH for scheduling the retransmission of the Msg3 is received before the random access contention resolution timer expires, skipping, by the terminal device, considering that contention resolution fails.

In some embodiments, in an NTN system, in a case that the random access contention resolution timer expires and the PDCCH for scheduling the retransmission of the Msg3 is received before the random access contention resolution timer expires, the terminal device does not consider that the contention resolution fails. In a TN system, in a case that the random access contention resolution timer expires and the PDCCH for scheduling the retransmission of the Msg3 is received before the random access contention resolution timer expires, the terminal device considers that the contention resolution fails.

In some other embodiments, in an NTN system and a TN system, in a case that the random access contention resolution timer expires and the PDCCH for scheduling the retransmission of the Msg3 is received before the random access contention resolution timer expires, the terminal device does not consider that the contention resolution fails.

Further, in a case that the terminal device does not consider that the contention resolution fails, the terminal device retransmits the Msg3 and restarts the random access contention resolution timer, and determines, according to a receiving status of a Msg4 during running of the random access contention resolution timer, whether the contention resolution succeeds. For a restart occasion of the random access contention resolution timer, refer to related descriptions in the foregoing Embodiment 1 to Embodiment 4. Details are not described herein again.

In an example, in a case that the PDCCH for scheduling the retransmission of the Msg3 is received before the random access contention resolution timer expires, the terminal device retransmits the Msg3, and restarts the random access contention resolution timer after a first time offset following retransmission of the Msg3. During running of the random access contention resolution timer, the terminal device monitors a PDCCH scrambled by a C-RNTI or a TC-RNTI, to receive a Msg4. In a case that a PDSCH that carries the Msg4 is received, it is determined whether contention is resolved by determining whether a contention resolution identifier in a CCCH SDU in the PDSCH and a terminal identity carried in the Msg3 match. For example, in a case that the contention resolution identifier match the terminal identity, it is considered that the contention resolution succeeds, and otherwise, it is considered that the contention resolution fails, and random access is initiated again.

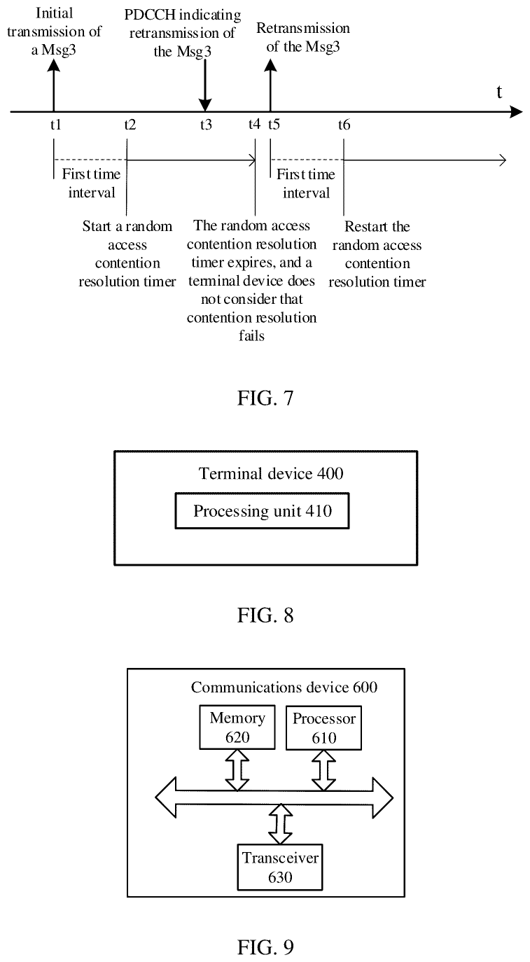

With reference to FIG. 7, an NTN scenario is used as an example to describe a mechanism for determining random access contention resolution according to an embodiment of this application. However, this application is not limited thereto.

As shown in FIG. 7, a terminal device performs initial transmission of a Msg3 at a time t1, and after a first time interval following completion of the initial transmission of the Msg3, starts a ra-ContentionResolution Timer at a time t2.

At a time t3, the terminal device receives a PDCCH that indicates retransmission of the Msg3 and is scrambled by a TC-RNTI, and the PDCCH indicates that the Msg3 is retransmitted at a time t5.

The ra-ContentionResolutionTimer expires at a time t4. Because the terminal device has received, at the time t3 before the ra-ContentionResolutionTimer expires, the PDCCH for scheduling the retransmission of the Msg3, the terminal device does not consider that contention resolution fails.

The terminal device performs retransmission of the Msg3 at a time t5, and after a first time interval following completion of the retransmission of the Msg3, starts the ra-ContentionResolutionTimer at a time t6.

During running of the ra-ContentionResolutionTimer, a PDCCH scrambled by a C-RNTI or a TC-RNTI is monitored, to receive a Msg4. For example, in a case that a PDSCH that carries the Msg4 is received, it is determined whether contention is resolved by determining whether a contention resolution identifier in a CCCH SDU in the PDSCH and a terminal identity carried in the Msg3 match. For example, in a case that the contention resolution identifier match the terminal identity, it is considered that contention resolution succeeds, and otherwise, it is considered that the contention resolution fails. If a quantity of times the terminal device sends a Msg1 is less than a threshold, of a maximum quantity of transmission times, configured by a network device, the terminal device initiates random access again.

In conclusion, in this embodiment of this application, in a case that a random access contention resolution timer expires and a PDCCH for scheduling retransmission of a message Msg3 is not received before the random access contention resolution timer expires, a terminal device considers that contention resolution does not succeed; and/or, in a case that the random access contention resolution timer expires and the PDCCH for scheduling the retransmission of the message Msg3 is received before the random access contention resolution timer expires, the terminal device does not consider that contention resolution fails, and further determines, according to a receiving status of a Msg4 after the Msg3 is retransmitted, whether the contention resolution succeeds. This is conducive to avoiding a problem of the terminal device frequently initiating random access, where the problem is resulted from that the terminal device considers that contention resolution fails as soon as the random access contention resolution timer expires, so that a random access delay is reduced, thereby improving a random access success rate.

The foregoing describes method embodiments of this application in detail with reference to FIG. 6 to FIG. 7. The following describes apparatus embodiments of this application in detail with reference to FIG. 8 to FIG. 10. It should be understood that the apparatus embodiments correspond to the method embodiments. For similar descriptions, refer to the method embodiments.

FIG. 8 is a schematic block diagram of a terminal device 400 according to an embodiment of this application. As shown in FIG. 8, the terminal device 400 includes:
a processing unit 410, configured to: in a case that a random access contention resolution timer expires and a physical downlink control channel PDCCH for scheduling retransmission of a message Msg3 is not received before the random access contention resolution timer expires, consider that contention resolution does not succeed.

In some embodiments of this application, the random access contention resolution timer is started or restarted at a first time domain symbol after the Msg3 is sent.

In some embodiments of this application, the random access contention resolution timer is started or restarted at a first time domain symbol after a first time offset following sending of the Msg3.

In some embodiments of this application, the random access contention resolution timer is started or restarted in a subframe in which a first physical uplink shared channel PUSCH is retransmitted for a last time, and the first PUSCH is used to carry the Msg3.

In some embodiments of this application, the random access contention resolution timer is started or restarted after a first time offset following a subframe in which a second PUSCH is retransmitted for a last time, and the second PUSCH is used to carry the Msg3.

In some embodiments of this application, the processing unit 410 is further configured to:
in a case that the random access contention resolution timer expires and the PDCCH for scheduling the retransmission of the Msg3 is not received before the random access contention resolution timer expires, discard a temporary cell radio network temporary identifier TC-RNTI, where the TC-RNTI is used to scramble the PDCCH.

In some embodiments of this application, the processing unit 410 is further configured to:
in a case that the random access contention resolution timer expires and the PDCCH for scheduling the retransmission of the Msg3 is received before the random access contention resolution timer expires, skip considering that contention resolution fails.

In some embodiments of this application, the terminal device 400 further includes:
a communications unit, configured to: in a case that the PDCCH for scheduling the retransmission of the Msg3 is received before the random access contention resolution timer expires, retransmit the Msg3;
the processing unit is 410 is further configured to restart the random access contention resolution timer after a first time offset following the retransmission of the Msg3;
the communications unit is further configured to: during running of the random access contention resolution timer, monitor a PDCCH that is scrambled by a cell radio network temporary identifier C-RNTI or a TC-RNTI and sent by a network device.

In some embodiments of this application, the first time offset is determined according to a round-trip time RTT between the terminal device and a network device.

In some embodiments of this application, the terminal device is a terminal device in a non-terrestrial networks NTN system, or the terminal device is a terminal device in a TN system.

In conclusion, in embodiments of this application, in a case that a random access contention resolution timer expires and a PDCCH for scheduling retransmission of a message Msg3 is not received before the random access contention resolution timer expires, a terminal device considers that contention resolution does not succeed; and/or, in a case that the random access contention resolution timer expires and the PDCCH for scheduling the retransmission of the message Msg3 is received before the random access contention resolution timer expires, the terminal device does not consider that contention resolution fails, and further determines whether the contention resolution succeeds according to a receiving status of a Msg4 after the Msg3 is retransmitted. This is conducive to avoiding a problem of the terminal device frequently initiating random access, where the problem is resulted from that the terminal device considers that contention resolution fails as soon as the random access contention resolution timer expires, so that a random access delay is reduced, thereby improving a random access success rate.

In some embodiments, the foregoing communications unit may be a communications interface or a transceiver, or an input/output interface of a communications chip or a system-on-chip. The processing unit may be one or more processors.

It should be understood that the terminal device 400 according to embodiments of this application may correspond to a terminal device in the method embodiments of this application, and the foregoing and other operations and/or functions of units in the terminal device 400 are respectively used to implement corresponding procedures of the terminal device in the method 200 shown in FIG. 4 to FIG. 7. For brevity, details are not described herein again.

FIG. 9 is a schematic structural diagram of a communications device 600 according to an embodiment of this application. The communications device 600 shown in FIG. 9 includes a processor 610, and the processor 610 may invoke a computer program from a memory and run the computer program to implement a method in embodiments of this application.

Optionally, as shown in FIG. 9, the communications device 600 may further include a memory 620. The processor 610 may invoke a computer program from the memory 620 and run the computer program to implement a method in embodiments of this application.

The memory 620 may be a separate component independent of the processor 610, or may be integrated into the processor 610.

Optionally, as shown in FIG. 9, the communications device 600 may further include a transceiver 630. The processor 610 may control the transceiver 630 to communicate with another device, and specifically, may send information or data to the another device, or receive information or data sent by the another device.

The transceiver 630 may include a transmitter and a receiver. The transceiver 630 may further include an antenna, and a quantity of antennas may be one or more.

Optionally, the communications device 600 may be a network device in embodiments of this application, and the communications device 600 may implement corresponding procedures implemented by the network device in methods in embodiments of this application. For brevity, details are not described herein again.

Optionally, the communications device 600 may be specifically a mobile terminal or a terminal device in embodiments of this application, and the communications device 600 may implement corresponding procedures implemented by the mobile terminal or the terminal device in methods in embodiments of this application. For brevity, details are not described herein again.

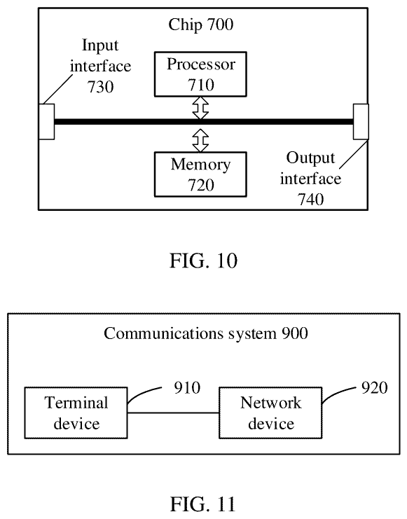

FIG. 10 is a schematic structural diagram of a chip according to an embodiment of this application. The chip 700 shown in FIG. 10 includes a processor 710, and the processor 710 may invoke a computer program from a memory and run the computer program to implement a method in embodiments of this application.

Optionally, as shown in FIG. 10, the chip 700 may further include a memory 720. The processor 710 may invoke a computer program from the memory 720 and run the computer program to implement a method in embodiments of this application.

The memory 720 may be a separate component independent of the processor 710, or may be integrated into the processor 710.

Optionally, the chip 700 may further include an input interface 730. The processor 710 may control the input interface 730 to communicate with another device or chip, and specifically, may obtain information or data sent by the another device or chip.

Optionally, the chip 700 may further include an output interface 740. The processor 710 may control the output interface 740 to communicate with another device or chip, and specifically, may output information or data to the another device or chip.

Optionally, the chip may be applied to a network device in embodiments of this application, and the chip may implement corresponding procedures implemented by the network device in methods in embodiments of this application. For brevity, details are not described herein again.

Optionally, the chip may be applied to a mobile terminal or a terminal device in embodiments of this application, and the chip may implement corresponding procedures implemented by the mobile terminal or the terminal device in methods in embodiments of this application. For brevity, details are not described herein again.

It should be understood that the chip mentioned in this embodiment of this application may also be referred to as a system-level chip, a system chip, a chip system, or a system-on-chip.

FIG. 11 is a schematic block diagram of a communications system 900 according to an embodiment of this application. As shown in FIG. 11, the communications system 900 includes a terminal device 910 and a network device 920.

The terminal device 910 may be configured to implement corresponding functions implemented by the terminal device in the foregoing method, and the network device 920 may be configured to implement corresponding functions implemented by the network device in the foregoing method. For brevity, details are not described herein again.

It should be understood that, a processor in embodiments of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (Electrically EPROM, EEPROM), or a flash memory. The volatile memory may be a random access memory (RAM), and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). It should be noted that, the memory in the systems and methods described in this specification includes but is not limited to these memories and any memory of another proper type.

It should be understood that, by way of example but not limitative description, for example, the memory in this embodiment of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct Rambus random access memory (Direct Rambus RAM, DR RAM), or the like. In other words, the memory in this embodiment of this application includes but is not limited to these memories and any memory of another proper type.

An embodiment of this application further provides a computer-readable storage medium, configured to store a computer program.

Optionally, the computer-readable storage medium may be applied to a network device in embodiments of this application, and the computer program causes a computer to execute corresponding procedures implemented by the network device in the methods in embodiments of this application. For brevity, details are not described herein again.

Optionally, the computer-readable storage medium may be applied to a mobile terminal or a terminal device in embodiments of this application, and the computer program causes a computer to execute corresponding procedures implemented by the mobile terminal or the terminal device in the methods in embodiments of this application. For brevity, details are not described herein again.

An embodiment of this application further provides a computer program product, which includes computer program instructions.

Optionally, the computer program product may be applied to a network device in embodiments of this application, and the computer program instructions cause a computer to execute corresponding procedures implemented by the network device in the methods in embodiments of this application. For brevity, details are not described herein again.

Optionally, the computer program product may be applied to a mobile terminal or a terminal device in embodiments of this application, and the computer program instructions cause a computer to execute corresponding procedures implemented by the mobile terminal or the terminal device in the methods in embodiments of this application. For brevity, details are not described herein again.

An embodiment of this application further provides a computer program.

Optionally, the computer program may be applied to a network device in embodiments of this application. The computer program, when running on a computer, causes the computer to execute corresponding procedures implemented by the network device in the methods in embodiments of this application. For brevity, details are not described herein again.

Optionally, the computer program may be applied to a mobile terminal or a terminal device in embodiments of this application. When the computer program runs on a computer, the computer executes corresponding procedures implemented by the mobile terminal or the terminal device in the methods in embodiments of this application. For brevity, details are not described herein again.

A person of ordinary skill in the art may be aware that, units and algorithm steps in examples described in combination with embodiments disclosed in this specification can be implemented by electronic hardware or a combination of computer software and electronic hardware. Whether the functions are executed by hardware or software depends on particular applications and design constraints of the technical solutions. A person skilled in the art may use different methods to implement the described functions for each particular application, but it should not be considered that the implementation goes beyond the scope of this application.

It may be aware by a person skilled in the art that, for the purpose of convenient and brief description, for a detailed working process of the foregoing system, apparatus, and unit, reference may be made to a corresponding process in the foregoing method embodiments. Details are not described herein again.

In the several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between apparatuses or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of embodiments.

In addition, function units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions of embodiments of this application essentially, or the part contributing to the conventional technology, or some of the technical solutions may be implemented in the form of a software product. The computer software product is stored in a storage medium and includes several instructions for instructing a computer device (which may be a personal computer, a server, a network device, or the like) to execute all or some of the steps of the methods described in embodiments of this application. The foregoing storage medium includes various media that may store a program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. A wireless communication method, comprising:
in a case that a random access contention resolution timer expires and a physical downlink control channel (PDCCH) for scheduling retransmission of a message Msg3 is not received before the random access contention resolution timer expires, considering, by a terminal device, that contention resolution does not succeed.

2. The method according to claim 1, wherein the random access contention resolution timer is started or restarted at a first time domain symbol after the Msg3 is sent.

3. The method according to claim 1, wherein the random access contention resolution timer is started or restarted at a first time domain symbol after a first time offset following sending of the Msg3.

4. The method according to claim 1, wherein the random access contention resolution timer is started or restarted in a subframe in which a first physical uplink shared channel (PUSCH) is retransmitted for a last time, and the first PUSCH is used to carry the Msg3.

5. The method according to claim 1, wherein the random access contention resolution timer is started or restarted after a first time offset following a subframe in which a second PUSCH is retransmitted for a last time, and the second PUSCH is used to carry the Msg3.

6. The method according to claim 1, wherein the method further comprises:
in a case that the random access contention resolution timer expires and the PDCCH for scheduling the retransmission of the Msg3 is not received before the random access contention resolution timer expires, discarding a temporary cell radio network temporary identifier (TC-RNTI), wherein the TC-RNTI is used to scramble the PDCCH.

7. The method according to claim 1, wherein the method further comprises:
in a case that the random access contention resolution timer expires and the PDCCH for scheduling the retransmission of the Msg3 is received before the random access contention resolution timer expires, skipping, by the terminal device, considering that contention resolution fails.

8. The method according to claim 1, wherein the method further comprises:
in a case that the PDCCH for scheduling the retransmission of the Msg3 is received before the random access contention resolution timer expires, retransmitting the Msg3 by the terminal device, restarting the random access contention resolution timer by the terminal device after a first time offset following the retransmission of the Msg3, and during running of the random access contention resolution timer, monitoring, by the terminal device, a PDCCH that is scrambled by a cell radio network temporary identifier (C-RNTI) or a TC-RNTI and sent by a network device.

9. The method according to claim 3, wherein the first time offset is determined according to a round-trip time (RTT) between the terminal device and a network device.

10. The method according to claim 1, wherein the method is applied to a non-terrestrial networks (NTN) system, or the method is applied to an NTN system and a terrestrial networks (TN) system.

11. A terminal device, comprising a processor and a memory, wherein the memory is configured to store a computer program, and the processor is configured to invoke and run the computer program stored in the memory to cause the terminal device to perform:
in a case that a random access contention resolution timer expires and a physical downlink control channel (PDCCH) for scheduling retransmission of a message Msg3 is not received before the random access contention resolution timer expires, considering that contention resolution does not succeed.

12. The terminal device according to claim 11, wherein the random access contention resolution timer is started or restarted at a first time domain symbol after the Msg3 is sent.

13. The terminal device according to claim 11, wherein the random access contention resolution timer is started or restarted at a first time domain symbol after a first time offset following sending of the Msg3.

14. The terminal device according to claim 11, wherein the random access contention resolution timer is started or restarted in a subframe in which a first physical uplink shared channel (PUSCH) is retransmitted for a last time, and the first PUSCH is used to carry the Msg3.

15. The terminal device according to claim 11, wherein the random access contention resolution timer is started or restarted after a first time offset following a subframe in which a second PUSCH is retransmitted for a last time, and the second PUSCH is used to carry the Msg3.

16. The terminal device according to claim 11, wherein the processor is configured to invoke and run the computer program stored in the memory to cause the terminal device to further perform:
in a case that the random access contention resolution timer expires and the PDCCH for scheduling the retransmission of the Msg3 is not received before the random access contention resolution timer expires, discarding a temporary cell radio network temporary identifier (TC-RNTI), wherein the TC-RNTI is used to scramble the PDCCH.

17. The terminal device according to claim 11, wherein the processor is configured to invoke and run the computer program stored in the memory to cause the terminal device to further perform:
in a case that the random access contention resolution timer expires and the PDCCH for scheduling the retransmission of the Msg3 is received before the random access contention resolution timer expires, skip considering that contention resolution fails.

18. The terminal device according to claim 11, wherein the processor is configured to invoke and run the computer program stored in the memory to cause the terminal device to further perform:
in a case that the PDCCH for scheduling the retransmission of the Msg3 is received before the random access contention resolution timer expires, retransmitting the Msg3;
restarting the random access contention resolution timer after a first time offset following the retransmission of the Msg3; and
during running of the random access contention resolution timer, monitoring a PDCCH that is scrambled by a cell radio network temporary identifier (C-RNTI) or a TC-RNTI and sent by a network device.

19. The terminal device according to claim 13, wherein the first time offset is determined according to a round-trip time (RTT) between the terminal device and a network device.

20. The terminal device according to claim 11, wherein the terminal device is a terminal device in a non-terrestrial networks (NTN) system, or the terminal device is a terminal device in a terrestrial networks (TN) system.
